(19) United States
(12) Patent Application Publication
(10) Pub. No.: US 2002/0137462 A1
(43) Pub. Date: Sep. 26, 2002

(54) Communication system and method

(75) Inventor: Paul J. Rankin, Horley (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/096,610

(22) Filed: Mar. 13, 2002

(30) Foreign Application Priority Data
Mar. 20, 2001 (GB) 0106846.9
Sep. 13, 2001 (GB) 0122229.8

(51) Int. Cl. H04B 5/00

(52) U.S. Cl. 455/41; 455/402

(57) ABSTRACT

A communication system comprises a network of beacons and a power line carrier arrangement providing a back-end path for the network. The carrier arrangement carries control and/or data signals to and from the beacons. A communication method is also disclosed.

This invention relates to a communication system and to a communication method. In particular it relates to a system comprising a network of beacons and to a method of networking beacons.

Recent years have seen a great increase in subscribers world-wide to mobile telephone networks and, through advances in technology and the addition of functionalities, cellular telephones have become personal, trusted devices. A result of this is that a mobile information society is developing, with personalised and localised services becoming increasingly more important. Such “Context-Aware” (CA) mobile telephones are used with low power, short-range base stations in places like shopping malls to provide location-specific information. This information might include local maps, information on nearby shops and restaurants and so on. The user's CA terminal may be equipped to filter the information received according to pre-stored user preferences and the user is only alerted if an item of data of particular interest has been received.

In an example of a CA terminal, Hewlett-Packard has posted a publication on the Web at:

<http://www.cooltown.hp.com/papers/webpres/Web/Presence.htm> about their “Cooltown” project. The convergence of Web technology, wireless networks and portable client devices provides design opportunities for computer/communications systems. In the Cooltown project, systems that are location-aware can be created using URL's for addressing, physical URL's for delivery via beacons and sensing of URL's for discovery, and localised web servers for directories. The systems are ubiquitous to support nomadic users. On top of this infrastructure the Internet connectivity can be leveraged to support communications services. Web presence bridges the World Wide Web and the physical world inhabited by the users, providing a model for supporting nomadic users without a central control point.

The Cooltown Museum and Bookstore offers visitors a Web-enhanced experience. As visitors tour the museum, their portable digital assistant (PDA) can receive Web URLs from wireless “beacons”. These beacons are small infrared transceivers located close to pictures or sculptures; the URLs link into a Web of information about the items. Using the PDA's Web browser, visitors can read or hear about the artist or the work and about related art works in the museum. The URLs can also be stored as bookmarks for further study or they can be used to select reproductions of the artwork from the museum's online store.

In connection with the delivery of audio data, there are many examples of one-way speech services in everyday use: apart from broadcast television and radio services, there are dial-up information services such as the speaking clock and recorded weather forecasts, as well as public address systems and display commentary systems used in a number of museums and art galleries. Each of these has different characteristics, but all are essentially unidirectional non-interactive services.

Communications protocols such as the Bluetooth standards could be used to provide access to such audio-based services in conventional fashion, by allowing portable terminals to join a piconet and request a point-to-point link over which the required audio stream may be sent. As will be recognised, however, a broadcast mechanism has a number of advantages for both terminal and base-station or beacon. Firstly, through not requiring the portable device to transmit (to join the piconet), battery power for the portable device is conserved. Secondly, the broadcasting beacon can reach many portable devices simultaneously, which may be of particular importance in crowded environments. In terms of security considerations for the user, through not being required to transmit, the portable device is not required to divulge its identity. Lastly, routing broadcast data through a single broadcast channel, rather than selectively over several point-to-point links, is easier to implement.

When a beacon is installed as part of a network, consideration is required as to the method by which broadcast data for the beacon is transferred to that beacon. It is known that data can be stored locally at the beacon, but then the only way of updating the beacon is manually, which is inefficient. A dedicated wired connection may be provided for the beacon as a way of transferring data to the beacon but this has the problem that in many situations the provision of such a connection is expensive and/or unpractical. It is also possible to communicate data to a beacon by a wireless connection but this again has a number of problems including cost, lack of broadcast bandwidth, interference and in some cases the inability to reach the beacon wirelessly.

It is an object of the invention to provide an improved communication system and method.

According to a first aspect of the present invention, there is provided a communication system comprising a network of beacons and a power line carrier arrangement providing a back-end path for said network of beacons, said carrier arrangement for carrying control and/or data signals.

According to a second aspect of the present invention, there is provided a communication method comprising networking a plurality of beacons, providing a back-end path for said beacons in the form of a power line carrier arrangement, and carrying control and/or data signals on said power line carrier arrangement.

Owing to these aspects of the invention it is possible to provide a communication system and method that, by using a power line carrier as the back-end path, facilitates communication with beacons in the network.

Advantageously a central server is provided that communicates with the beacons of the network. Control and/or data signals are carried by the power line carrier arrangement and this communication can be bi-directional, with signals able to travel back from the beacons. Each beacon can be provided with a cache memory for storing data that can be updated by the central server. The server can also be arranged to reconfigure any of the beacons.

For the beacon back-end path, ‘Power Line Carrier’ (PLC) schemes for modulating 110 or 240V mains supplies are used to carry control and/or data signals. Depending upon the scheme adopted, its noise insensitivity and effective data rate, isolation from outside interference etc, some or all of the back-end network data and control functions needed by beacons can be supported via PLC. X-10 as a particular example, gives 120 b/s, therefore providing a cheap way for immediately installing up to 256 simple stand-alone RF beacon units in a locale, piggy-backing on the mains cable installation to support one style of application design (those where the beacon does not have to rapidly communicate discovered handset id's across the back-channel to a central server, i.e. where the short-range RF communication is essentially one way, from beacon to handset—this may optionally exploit RF connectionless broadcasting).

Embodiments of the invention will now be described, by way of example only, with reference to the accompanying drawings in which:-

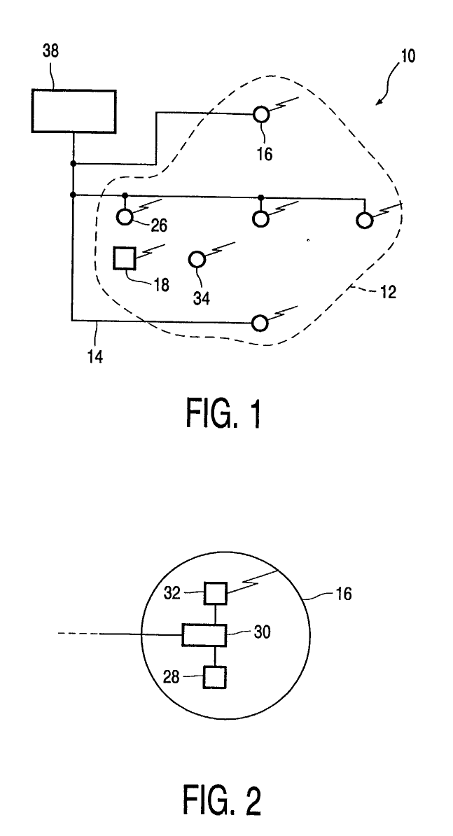

FIG. 1 is a schematic representation of a communication system,

FIG. 2 is a schematic representation of a beacon of the communication system of FIG. 1,

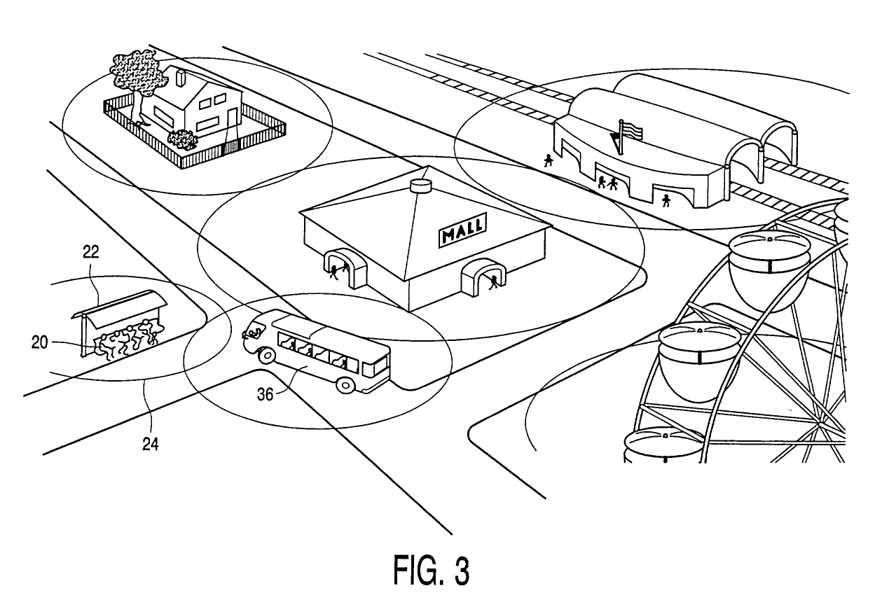

FIG. 3 is a stylised perspective view of a locality in which the communication system of FIG. 1 is installed, and

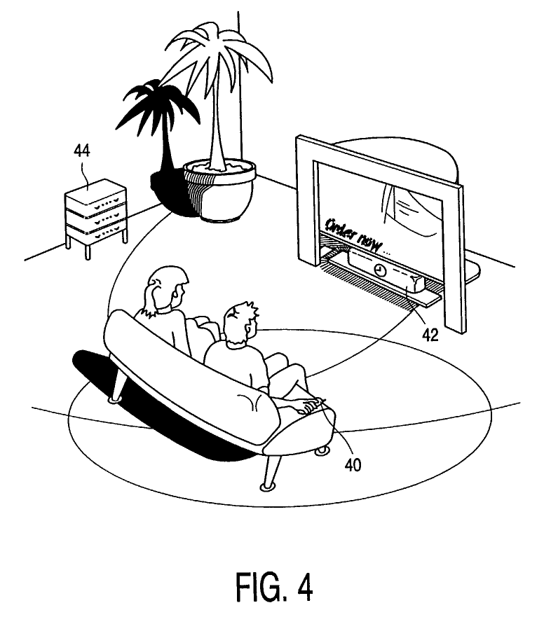

FIG. 4 is a stylised perspective view of a second locality with a communication system installed therein.

In FIG. 1, a communication system 10 comprises a network of beacons 12 and a power line carrier arrangement 14. The carrier arrangement 14 is providing a back-end path for the network of beacons 12. The carrier arrangement 14 enables remote communication with the beacons via the mains power supply which is modulated for carrying control and/or data signals. The carrier arrangement 14 is a two-way channel that carries signals both to and from the individual beacons 16. Control signals would typically be such things as turning the beacon on and off, adjusting the broadcast interval, switching to a different data set in response to an external event or schedule and so on. Data signals would be the actual information or signal broadcast by the individual beacon.

The carrier arrangement 14 also supplies the necessary power to the individual beacons 16 for their operation. The beacons, in this example, are short range RF beacons of the Bluetooth standard that broadcast locally in a CA (Context Aware) network. Other beacon broadcasting systems are possible including Zigbee and 802.11b and also IR based systems. The beacons broadcast over ranges up to 100m, having typically 1m, 10m or 100m ranges. A CA network is arranged to communicate with mobile phones, PDAs and similar devices that are present within the network. For example a beacon of a CA network may be placed at a shop front and can broadcast details of the most recently available products or details of special offers. These broadcasts are received by shoppers who are passing the shop front and have CA functionality on their mobile communication device and who can take advantage of the information received from the CA network.

Such a mobile communication device could be, for example, a mobile phone 18 in the possession of a user 20 who in present at a bus stop 22 (shown in FIG. 3). The user 20 is within the range 24 of a Bluetooth beacon 26, which is a broadcast only beacon that broadcasts bus timetable information. The power line carrier arrangement 14 provides a back-end path to this beacon 26 that can be used to send new data to the beacon 26. For example, if there is a change in the timetable caused by a delay in the road traffic system then this change can be communicated to the beacon 26 via the carrier arrangement 14. If a whole new timetable is to be uploaded to the beacon 26 then this is ideally carried out during a time interval when the beacon 26 is not broadcasting, i.e. at night. The carrier arrangement can be used to switch between different data sets in response to external events, the data sets being precached in the beacon.

The beacon 16 is shown in more detail in FIG. 2. The beacon 16 is provided with a cache memory 28 in addition to a processor 30 and a broadcast chip 32. These different functional objects can be provided by a single component. The other beacons in the network 12 are similarly provided with cache memories that facilitate the updating of each beacon.

In addition to the sending of data to a beacon, the power line carrier arrangement 14 can act as a two-way channel, carrying data back from those beacons that are not broadcast only beacons. A two-way beacon will repeatedly issue a call signal that can be received by a suitably enabled CA mobile communication device. When such a signal is received by a CA device then the device replies and a two-way communication channel is opened. The CA device will typically have stored on it some kind of user profile and this profile can be interrogated by the CA system to decide what, if any, communication is sent to the CA device.

For example, a CA beacon at the entrance to a music store may interrogate CA mobile phones entering its range to see if the user has a music parameter present in the user's profile. If present, the beacon will send the CA mobile device details of, for example, a 3 for 2 offer on CDs, currently running in the music store or may send an ecoupon to the device. However the beacon may also receive more, or related, details from the user's profile that are then passed via the carrier arrangement 14 (acting as a back channel) to other beacons in the network 12. This may be details of the particular type of music of which the user is fond, or may relate to the user's preference for such things as music videos. When the user subsequently enters the part of the store dedicated to music videos, which an associated CA beacon covers, then the user will receive information relevant to their music video tastes. This communication between device and network can be automatic or can be consensual, based upon the user's acceptance of such communication when he first enters the store.

In a CA system other uses of the carrier arrangement are possible, including the transmission of fairly simple information from beacons. For example, this may be the identity of discovered devices, or the number of discovered devices per hour. The carrier arrangement may also be used to receive feedback on the use of services that are broadcast by the beacons and thereby select from precached options. For example, if one beacon is broadcasting a 3 for 2 offer, and a second beacon is broadcasting an offer of half price on selected items, the take up of these offers can be monitored and the more popular offer can then be broadcast on both beacons. The carrier arrangement can also be used to upload information to beacons on-demand that has been requested by a CA mobile device user.

Beacons within the network can themselves be mobile; for example a mobile beacon 34 is located on a bus 36. This beacon 34 has the primary purpose of communicating with passengers on the bus 36, for example providing information on shops and facilities on the route ahead, and giving timetable details etc. However when the bus 36 reaches a scheduled bus stop, for example, bus stop 22, the range of the mobile beacon 34 will extend to reach users who are waiting at the bus stop 22 and can communicate with any CA enabled devices held by those users. They can be informed of such things as the route of the bus 36 etc. The mobile beacon 34 can be updated when it is within the range of a fixed beacon via the power line carrier arrangement 14 connected to that beacon and the broadcast from the fixed beacon.

The system includes a central server 38 for communicating with the beacons of the network 12 via the power line carrier arrangement 14. The central server 38, which is remote from the beacons, is arranged to periodically update the cache memory of each beacon. The beacons can be updated on a regular basis, as appropriate. Ideally, the server is arranged to update the cache memory during a time period when the associated beacon is not broadcasting.

It is also possible to operate a dynamic system where the beacons can be updated as and when desired, according to changing circumstances. If the beacons of the network 12 cover, for example, a large department store, then the server 38 can be located in a central control room and its operator can, via a suitable user interface, update the individual beacons.

The central server 38 is also arranged to reconfigure the beacons of the network 12. The server 38 can also reconfigure the entire network of beacons, The reconfiguring may be, for example changing one or more of the beacon's RF mode, protocol or profile. In this way an operator can reconfigure a local area network of beacons. For example, a beacon that is operating as a broadcast only beacon can be reconfigured to act as a two-way beacon. Reconfiguring also includes such actions as turning a beacon on or off and altering the frequency/rate of broadcasting or inquiry. In the Bluetooth system some beacons can act as inquirers or interactors, this can be reconfigured via the power line carrier arrangement. Activation of a subset of service offers/alerts at different times of day can also be configured by the carrier arrangement.

FIG. 4 shows a communication system installed in-home. Various devices, such as a mobile phone 40, set top box 42 and audio system 44 are provided with beacons, which could be integrated circuits of the Bluetooth standard. A power line carrier arrangement, in the form of the mains power supply provides a back-end path for the network of beacons, and control and/or data signals can be transmitted and received by the beacons.

In addition to the home, such a communication system can be installed in the office or at least a part of the system can be installed in vehicles. The powerlike carrier arrangement can run on voltages other than mains voltage so a vehicles internal power circuits can be used as the carrier arrangement.

1. A communication system comprising a network of beacons and a power line carrier arrangement providing a back-end path for said network of beacons, said carrier arrangement for carrying control and/or data signals.

2. A system according to claim 1, wherein at least one of said beacons is a broadcast only beacon.

3. A system according to claim 1, wherein at least one of said beacons is a short-range RF beacon.

4. A system according to claim 1, wherein at least one of said beacons is arranged to communicate with a mobile communication device.

5. A system according to claim 1, wherein at least one of said beacons is a mobile beacon.

6. A system according to claim 1, wherein said carrier arrangement is a two-way channel.

7. A system according to claim 1, wherein at least one of said beacons includes a cache memory.

8. A system according to claim 1, and further comprising a central server for communicating with said beacons via said carrier arrangement.

9. A system according to claim 8 as appended to claim 7, wherein said central server is arranged to periodically update said cache memory.

10. A system according to claim 9, wherein said server is arranged to update said cache memory during a time interval when the associated beacon is not broadcasting.

11. A system according to claim 8, wherein said server is arranged to reconfigure a beacon of said network.

12. A system according to claim 8, wherein said server is arranged to reconfigure said network.

13. A communication method comprising networking a plurality of beacons, providing a back-end path for said beacons in the form of a power line carrier arrangement, and carrying control and/or data signals on said power line carrier arrangement.

14. A method according to claim 13, wherein at least one of said beacons is a broadcast only beacon.

15. A method according to claim 13, wherein at least one of said beacons is a short-range RF beacon.

16. A method according to claim 13, wherein a beacon of said network is communicating with a mobile communication device.

17. A method according to claim 13, wherein at least one of said beacons is a mobile beacon.

18. A method according to claim 13, wherein said carrying is two-way.

19. A method according to claim 13 wherein at least one of said beacons includes a cache memory.

20. A method according to claim 13 and further comprising communicating with said beacons from a central server.

21. A method according to claim 20 as appended to claim 19, said communicating occurring periodically and for the purpose of updating said cache memory.

22. A method according to claim 21, wherein said updating of said cache memory takes place during a time interval when the associated beacon is not broadcasting.

23. A method according to claim 20 wherein the communicating from said central server is to reconfigure a beacon of said network.

24. A method according to claim 20, wherein the communicating from said central server is to reconfigure said network.
